(19) United States
(12) Patent Application Publication
(10) Pub. No.: US 2011/0144414 A1
(43) Pub. Date: Jun. 16, 2011

(54) MIDDLE EAR IMPLANT AND METHOD

(75) Inventors: Michael R. Spearman, The Woodlands, TX (US); Brian M. Spearman, The Woodlands, TX (US); Eric M. Hollnagel, The Woodlands, TX (US); Eric M. Kraus, Greensboro, NC (US)

(73) Assignee: Ototronix, LLC, Houston, TX (US)

(21) Appl. No.: 12/896,132

(22) Filed: Oct. 1, 2010

Related U.S. Application Data
(60) Provisional application No. 61/247,742, filed on Oct. 1, 2009.

(51) Int. Cl. H04R 25/00

(52) U.S. Cl. 600/25

(57) ABSTRACT

An improved middle ear implant and method are disclosed. The invention particularly relates to magnetic implants and to attachment devices and methods for mounting a magnet in the middle ear of a patient. The implant comprises a wire-form and a magnet disposed in a housing. The method may comprise the steps of: positioning a magnet in optimal alignment; and attaching said magnet to an ossicle in the middle ear. The method may further comprise the step of using a wire-form to attach the implant to the ossicle. Still further, the method may comprise the step of anchoring the implant to the ossicle with biological cement.

This application claims the benefit of U.S. provisional patent application No. 61/247,742, filed on Oct. 1, 2009. The contents of this provisional application are fully incorporated herein by reference.

### FIELD OF THE INVENTION

The present invention relates generally to the field of middle ear implants and improvements in obtaining sound quality for middle ear implant patients. The invention more particularly relates to improved apparatus and methods used in, or with, magnetic middle ear hearing systems. The present invention most particularly relates to improved magnetic implants and to improved attachment devices and methods for mounting a magnet in the middle ear of a patient.

### BACKGROUND OF THE PRESENT INVENTION

There are many different reasons why some people have hearing impairment. In general, however, sound entering the outer ear canal does not get transmitted to the inner ear and/or transmitted to the auditory nerve. In some instances, this can be solved by amplifying the sound with a hearing aid put in the outer ear canal. In other cases, a cochlear implant device that electrically stimulates the auditory nerve directly needs to be implanted in the cochlea of the inner ear. In still other situations, a middle ear device that creates mechanical vibrations is needed. The present invention pertains to such middle ear devices, and specifically magnetic middle ear devices.

A person's normal middle ear includes a chain of small bones, or ossicles. The malleus, the incus, and the stapes form this chain; and, when functioning normally, these ossicles transmit mechanical vibrations from the eardrum, or tympanic membrane, at the end of the outer ear canal to the oval window into the inner ear. When something is defective in this ossicular chain, however, such transmission does not occur sufficiently to stimulate the cochlea and/or the auditory nerve. Alternatively, if transmission through the ossicular chain is normal, but the inner ear hair cells are damaged or absent, the auditory nerve may receive less stimulation. Either way, greater amplitude of ossicular movement will help correct the hearing deficit.

One general solution to hearing problems caused by middle ear deficiencies is to implant a magnet in the middle ear and to cause the magnet to vibrate in response to environmental sounds. The magnet is connected, for example, such that it provides mechanical vibrations to the oval window, either through an adequately functioning portion of the middle ear's ossicular chain to which the magnet is attached, or through an implanted prosthesis carrying the magnet and communicating with the oval window.

A number of middle ear magnet attachment devices have been proposed. Some clip to an ossicle, or part of one; others abut ossicular surfaces; others have wires or rods attached to transducers; others have probes connected to transducers wherein the probes must fit into holes placed in the ossicles; others have closed loops that slide over a portion of the ossicular chain; and others use surface tension forces that seek to hold an implant onto the living epithelium of the round window of the inner ear.

Each of these proposed methods have shortcomings. Regardless of the particular implant or mounting technique used for a middle ear magnet, problems can arise with regard to alignment of the magnetic with the magnetic field.

When a coil of wire is energized by the flow of electricity, it becomes an “electromagnet” whose magnetic strength and polarity are based on the direction and strength of the electric current energizing it. If a permanent magnet is placed near this electromagnetic coil, the magnet will be attracted to or repelled from the coil. The induced vibration of the magnet is what acts to ultimately stimulate the oval window. With an extra-coil electromagnetic (ECE) transducer, the coil is placed in the ear canal, and the magnet is located at some distance away from the coil along the coil's axis. However, the nature of the ECE transducer is such that the power delivered by the coil to the magnet is sensitive to the coil-magnet alignment.

If the implanted magnet is not optimally aligned with the external coil from which the electromagnetic signal propagates, the implanted magnet might not respond adequately. By “optimally aligned” is meant that the attached magnet is axially aligned with the electromagnetic coil, or the extra-coil electromagnetic transducer (ECE), and generally aligned along the axis of the ear canal. This is very important as the position and angle of the ossicular chain varies in the anatomy from patient to patient. For example, the angle of the stapes to the external auditory canal can vary from patient to patient. Thus, a magnet that has been rigidly clamped to the incudostapedial joint of the ossicular chain will not necessarily be at the optimum alignment to the ear canal and can be misaligned.

A disadvantage of clip mechanisms known in the prior art is difficulty in aligning the magnet with different patient anatomies. It is desirable to have the magnet aligned axially to the ear canal so that ECE transducer in the ear canal is aligned axially with it. If the magnet is at an angle to the coil, energy transfer efficiency will be lost. In many patients, the stapes is not aligned axially to the ear canal. Therefore, if a magnet is clipped onto the stapes, which is itself at an angle to the ear canal, then the coil and magnet will not be properly aligned, and energy transfer to the magnet and, consequently, the ossicular chain and cochlea, will be diminished

Clamping or clipping onto living bone (ossicles) can also compromise oxygen and nutrient delivery, thus resulting in necrosis of the ossicles. In order to prevent this, U.S. Pat. No. 6,712,754 (Dormer) proposed the use of circular loops or rings which were slightly larger than the ossicle. Circular wire rings rely upon tissue formation to secure the implant to the ossicular chain. However, this can result in a loose fit, and if the magnet is allowed to vibrate loosely about the ossicle, this will result in loss of performance and a “rattling” effect for the patient. Even when tissue does form, tissue itself is relatively soft and elastic. Thus, it does not transmit vibrations as well as a rigid connection.

Another disadvantage of this type of mechanism is that the tissue formation required to create contact between the coils and ossicles takes several weeks to form after surgery. As a result, the orientation of the magnet may move during the healing time, and can become permanently misaligned once the tissue forms. In addition, the circular ring method, known in the prior art, requires disconnecting the incus of the middle ear from the stapes of the middle ear and sliding the loop onto the stapes. It is not desirable to do this as the ossicular chain is quite delicate and a mishap could result in additional or total hearing loss.

Changes in position of implanted magnets can occur from a variety of causes. For example, implant surgeons have different techniques and skills, and thus magnet location may vary because of differences in surgeons. As another example, one particular type of attachment device might orient its magnet differently from how another particular type of attachment device orients its magnet even though the magnets are located at the same ossicular position in the respective patients.

As a further example, anatomical differences between patients can cause similarly located magnets to be oriented differently relative to an external device (such as an external electromagnetic signal generating unit in the person's outer ear canal). As stated above, changes in orientation can also occur during the healing process following the implantation surgery. For example, known support structures, such as GELFOAM™, which is used to hold a magnet in position during the healing process, may become dislodged and allow the magnet to move; tissue growth may occur non-uniformly between the magnet and the ossicle, thus altering the initial position of the magnet; and forceful physical activities may move the magnet out of position prior to tissue fully encapsulating it.

Thus, there is the need for an attachment device and method, as well as an overall implant, which overcomes these shortcomings in the prior art, and which enables an implant to be placed, and secured, reliably, and in optimal alignment with the external coil.

### SUMMARY OF THE INVENTION

The present invention overcomes the above-noted and other shortcomings of the prior art by providing a novel and improved implant and attachment device and method for mounting a magnet in a middle ear of a patient in optimal alignment with an electromagnetic coil or extra coil electromagnetic (ECE) transducer.

The present invention allows for biologically compatible, non-necrotizing, light weight, anatomical positioning of a magnetic implant onto the ossicular chain of a patient. It provides a specific orientation at the location of implantation which preferably does not change or move once implanted. The present invention allows the magnet implant to be aligned precisely despite changes in middle ear anatomy from one patient to another.

In addition, it provides for a rigid connection between the magnet and ossicles, thereby providing maximum transmission of vibrations to the ossicle, yet does not apply a force to the ossicle to create the rigid connection. Thus, the connection mechanism does not compromise blood supply or nutrient flow. The ossicular chain does not need to be separated in implanting the device. Such mounting provides for lifetime implantation on an intact ossicular chain.

The present invention also provides a method of mounting a magnetic implant in a middle ear. This method comprises positioning the magnet in the optimal alignment, and then using biocompatible cement to adhere the magnet to the ossicle. Preferably, the cement forms a cast-like structure completely around the tissue of the ossicle and adheres to the magnet. Alternately, the cement may bond directly to the ossicle itself if tissue is removed.

Preferred biocompatible cements include hydroxylapatite and glass ionomer cements, although other biocompatible cements or glues may also be used.

In another embodiment, a wire-form may be attached to the magnet. The wire-form is placed loosely around the ossicle and the magnet is positioned in the optimal alignment with the outer ear canal and exterior coil. Biocompatible cement is then used to adhere the magnet to the ossicle with the wire-form as a scaffold structure within the cement.

The wire-form may consist of a single wire or band, or two or more wires or bands. In a preferred embodiment, it consists of a wire-form attached to the magnetic implant with two wire-formed structures projecting from the implant. Each of these wire-form structures fit on opposite sides of an ossicle. They may be circular, oval, rectangular or of other geometric configurations. The wire-form serves as the scaffold structure for the cement to bond totally around the ossicle. The wire-form should preferably have a configuration that facilitates wicking of cement into the wire-form structure

The wire-form structure is not limited to being made from wire, and may be made from bands, for example, and may be in any configuration that fits around the ossicle, provided that it does not apply a force upon the ossicle to hold the device in place and such that the device is freely moved about the ossicle to allow for proper alignment of the magnet with the ear canal prior to the application of the cement.

The wire-form material should be made from a metal which is biocompatible, such as titanium, gold, stainless steel or other known biocompatible metals. When using a wire-form, it is preferable to use a wire-form made from biocompatible metal alloys, such as such as NITINOL™, with shape memory properties. When the wire-form is made from a shape memory material, the surgeon may open the ring to allow for placing the wire-form around an ossicle, and then apply heat to return the wire-form to its original shape.

The primary advantages of a shape memory material include that it can be formed into a desired shape without permanently deforming the material. The material can be returned to its original shape by applying heat and without the use of mechanical force (e.g. crimping tool). If the material is inadvertently deformed into an undesired shape, it can be returned to its original shape by applying heat. The transition temperature set point can be established at a desired value by modifying the alloy composition and/or by heat treatment.

Above this transition set point the material has superelastic properties, and below this point the material has more plastic properties. “Superelastic”, or “very springy” properties may have advantages in certain applications where it is desirable for the material to return to the original shape after experiencing force; plastic properties may have advantages in certain applications where it is desirable for the material to conform to a new shape after experiencing force.

Other potential benefits of using shape memory material are that it reduces the number or types of tools required to conduct a surgical procedure. It provides for shorter duration of the procedure, and allows for access into smaller or obscured areas.

Shape memory material can be produced from a variety of alloys (e.g. copper-zinc-aluminum-nickel, copper-aluminum-nickel, and nickel-titanium, others). The material is formed, or worked, into the desired final shape. While remaining fixed in this desired final shape, the component is heat treated to form the crystalline structure unique to the desired final shape. This establishes the “shape memory”. After this point, the component is then capable of being deformed, or strained, into an intermediate shape, and can be reformed to the desired final shape by heating above its transition temperature. While there is a limit to the amount of deformation that can occur while still maintaining those original shape memory properties, the component can be deformed into an intermediate shape (e.g. open loop) and will maintain this shape indefinitely until heat or force is applied. This is known as a one-way shape memory application.

In a two-way shape memory application, the intermediate shape discussed above can be set, and through a series of heat treatment and shape setting steps, the material can achieve two memory states. While the material is above the transition temperature, it assumes the desired final shape, while below the transition temperature, the material assumes the intermediate shape. For instance, if the transition temperature was just below body temperature, then the intermediate shape could be below body temperature (during installation), and the desired final shape could be at body temperature (after installation). This would provide the advantage of allowing the body's natural temperature to form to the final, desired configuration and not requiring the use an external device to heat the wire-form.

Other methods of heating a shape memory material in middle ear procedures may include electro-cautery, laser or other heating means capable of temporarily heating the shape memory material above the transition temperature.

In yet another embodiment of the present invention a bi-metal material may be used. A bi-metal material is two or more layers of dissimilar metal materials laminated to each other. These two materials have dissimilar coefficients of thermal expansion, which converts a temperature change into mechanical displacement.

To use a bi-metal, the bi-metal wire-form or attachment is temporarily changed to an intermediate shape by heating it, thus causing the ring to expand and allowing the implant to be placed around the ossicle. When it cools, it returns to the original shape. Methods of heating a bi-metal material in middle ear procedures may include electro-cautery, laser or other heating means capable of temporarily heating the bi-metal material above the transition temperature.

It can be seen from the foregoing that many problems still exist in the art of middle ear implants, and those skilled in the art continue to search for a satisfactory solution to the problem of aligning a magnet with an electromagnetic coil, or an extra coil electromagnetic transducer.

Therefore, it is an object of the present invention to provide a novel and improved implant and attachment device and method for mounting a magnet in a middle ear of a patient. Other and further objects, features and advantages of the present invention will be readily apparent to those skilled in the art when the following description of the preferred embodiments is read in conjunction with the accompanying drawings.

### BRIEF DESCRIPTION OF THE DRAWINGS

FIG. 1 is an environmental view showing a partial cross-sectional view of the inner and outer ear with pertinent portions shown in cross-section. A construction embodying the present invention is also shown.

FIG. 2 is an enlarged, perspective view of a portion of the construction shown in FIG. 1.

FIG. 3 shows the construction of FIG. 2 attached to a portion of the ossicular chain with biocompatible cement.

FIG. 4 shows a modification of the construction shown in FIG. 2.

FIG. 5 illustrates a further modification of the construction shown in FIG. 2.

FIG. 6 illustrates a further modification of the construction shown in FIG. 2.

FIG. 7 illustrates a still further modification of the construction shown in FIG. 2.

FIG. 8 illustrates a still further modification of the construction shown in FIG. 2.

FIG. 9 is a view similar in part to FIG. 2 with bio-compatible cement used to attach the construction to a portion of the ossicular chain in place of a wire form.

FIG. 10 shows the construction of FIG. 2 in more detail.

FIG. 11 is an environmental view illustrating an anatomical configuration of the ossicular chain relative to the outer ear canal, with pertinent portions shown in cross-section

FIG. 12 is an environmental view illustrating the misalignment of a clamped magnet housing on an angled ossicle, with pertinent portions shown in cross-section

FIG. 13 is an environmental view illustrating a properly aligned magnet housing the method of the present invention on an angled ossicle; with pertinent portions shown in cross-section.

### DETAILED DESCRIPTION OF THE PREFERRED EMBODIMENTS

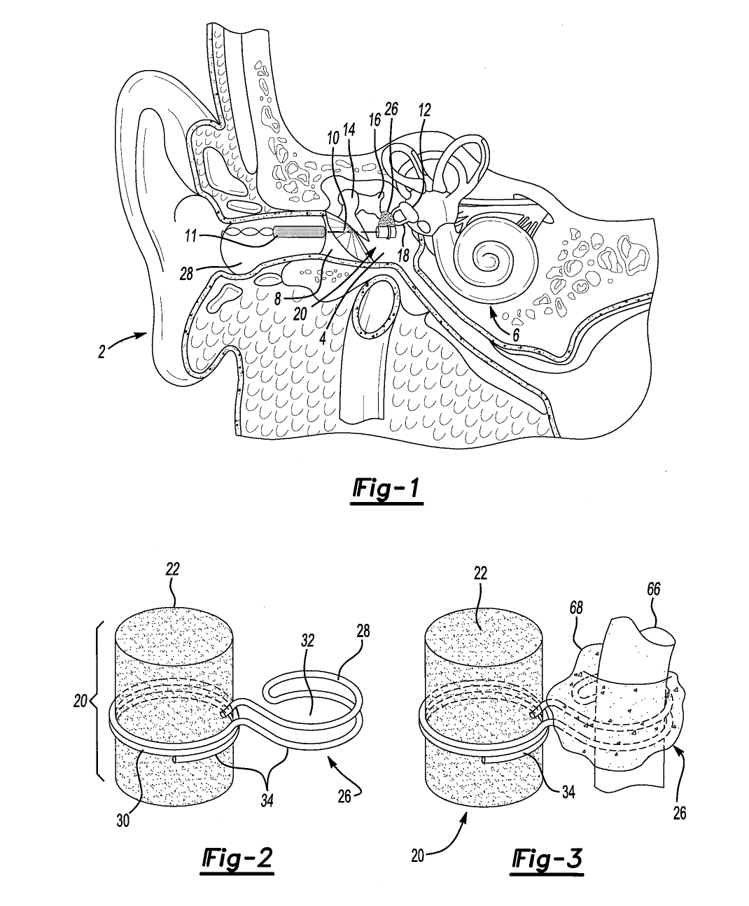

A human ear is represented in FIG. 1. It includes an outer ear 2, a middle ear 4, and an inner ear 6. Pertinent to the description of the present invention is an outer ear canal 8 which is normally closed at its inner end by tympanic membrane, or eardrum, 10. Also pertinent is an ossicular chain, which, if intact, extends from tympanic membrane 10 to oval window 12 defining an entrance to the inner ear 6. The intact ossicular chain extends through the middle ear 4 and includes a malleus 14, an incus 16, and a stapes 18. A properly functioning ossicular chain transmits vibrations from the tympanic membrane 10 in series through the malleus 14, the incus 16 and the stapes 18 to the oval window 12. Vibrations at the oval window stimulate the inner ear 6, whereby the person perceives the sound received in the outer ear 2.

An object of the present invention is to provide the vibratory stimulation to the inner ear 6 when there otherwise is inadequate vibration transmission in the person's middle ear 4. To accomplish this, the present invention provides an implant, generally designated by the numeral 20, for a middle ear of a patient. Also provided is an attachment device 26 for attaching the implant 20, as described herein below in optimal alignment with an electromagnetic coil or extra coil electromagnetic (ECE) transducer 11.

Referring to FIGS. 1, 2, 10, 12, and 13 the implant 20 comprises a housing or canister 22, and a magnet 80 disposed in the housing 22. In a preferred embodiment, the housing 22 is a commercially pure titanium canister, hermetically sealed and containing a rare earth permanent magnet (e.g., Nd.sub.2 Fe.sub.14 B) as the magnet 80.

The lid of the housing 22 is laser welded to the main body of the housing in an inert gas environment, excluding oxygen from the canister 22. Variations in the housing shape and size may be made to fit the implant so as to accommodate the anatomical structures of the ossicles. Such variations in the housing may fit intraossicular, interossicular or paraossicular ossicles. Variations may include those other than the preferred embodiment of a right cylinder.

As illustrated in FIGS. 1, 12, and 13, the attachment device 26 connects the implant 20, to at least a partial middle ear ossicle. “At least a partial middle ear ossicle” means that the attachment device 26 mounts on a functional part of an ossicular chain, which could be less than the entire ossicular chain or less than a single ossicle. It can also be used with a complete ossicular chain, whether functioning normally or not. The present invention can also be used with prosthesis for use in the middle ear in place of, or instead of, one or more parts of the ossicular chain. Thus, the present invention has general applicability to structure in the middle ear, whether such structure is natural or artificial.

FIG. 2 illustrates the attachment device 26 with a wire-form structure 34 in an open loop configuration. The wire-form structure 34 comprises at least wire-form loop 30 and open loop 32, and is preferably made from a single biocompatible wire 28. The open loop 32 is adapted to mount around or over the selected ossicular portion or middle ear prosthesis. The illustrated embodiment of the open loop 32 includes one wire 28 which is configured into a double-wire open loop 32. The internal loop diameter of the open loop 32 should be larger than the outer diameter of an ossicle so as to fit loosely around the ossicle. The preferred wire material is a biocompatible alloy of titanium, aluminum and vanadium (e.g., TiAl.sub.6 V.sub.4) or a nickel-titanium alloy with shape memory properties.

The wire-form loop 30 is connected to the open loop 32. The wire-form loop 30 is adapted to mount over the illustrated housing-magnet assembly 22. As illustrated, the wire-form loop 30 is disposed around the housing 22. This loop has a press fit around the housing 22 such that once the housing 22 is positioned relative to the wire-form loop 30 in a desired position (such as nominally 0.2 mm from the lid-end of the housing 22 for the illustrated implementations), the compressive force of the wire-form loop 30 around the outside of the housing 22 retains the housing 22 in that position. Alternatively, the wire-form loop 30 may be welded to the housing or a portion of loop 32 may be welded to the housing to create a rigid connection to the housing.

FIG. 3 illustrates the attachment device 26 of the present invention utilizing a wire-form structure 34 and biocompatible cement 68 to attach the housing to a portion of the ossicular chain 66. Preferably, the cement forms completely around the ossicle like a cast thus creating a rigid connection of the housing assembly to the ossicle.

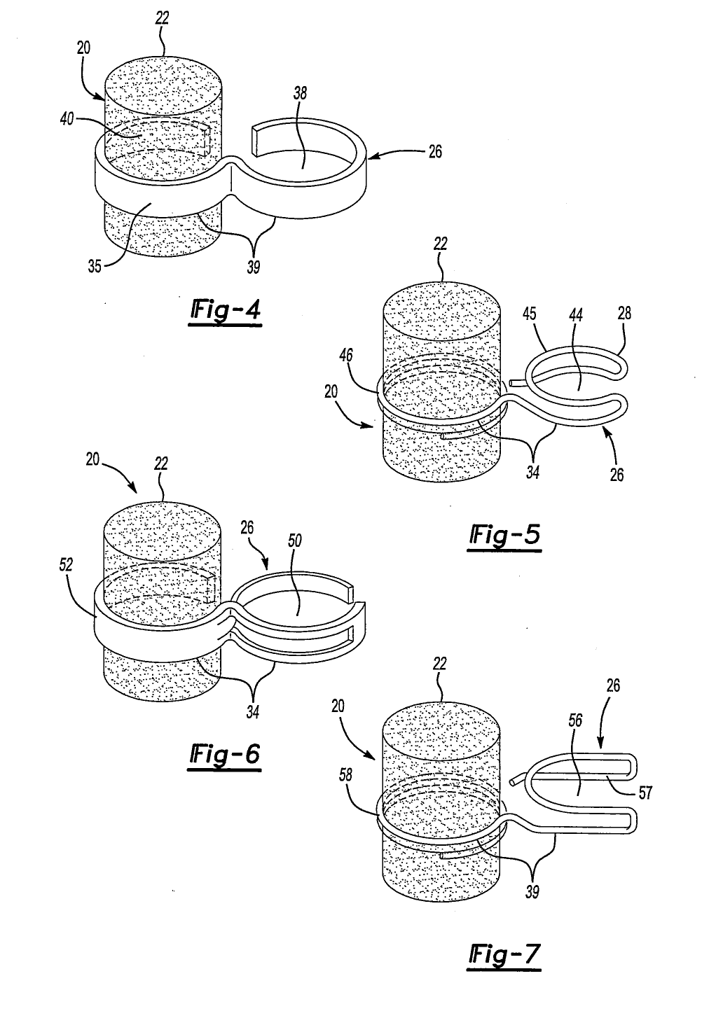

FIG. 4 illustrates the wire-form structure 34 in an open loop configuration made with a band 35. The wire-form structure 34 is made from a single biocompatible band 35 having a first portion or loop 38 adapted to mount around, or over, the selected ossicular portion or middle ear prosthesis, and a second portion 40, contiguous with the first portion or loop 38.

The internal loop diameter of the first portion 38 should be larger than the outer diameter of the ossicle so as to fit loosely around the ossicle. The band 35 is nominally 0.1 mm thick. The preferred wire material is a biocompatible alloy of titanium, aluminum and vanadium (e.g., TiAl.sub.6 V.sub.4) or a nickel-titanium alloy with shape memory properties.

The second portion or loop 40 is connected to the first portion or loop 38. The loop 40 is adapted to mount over the housing assembly 22. The second portion or loop 40 is disposed around the housing 22. As previously described, this loop has a press fit around the housing 22 such that once the housing 22 is slid relative to the loop 40 to a desired position (such as nominally 0.2 mm from the lid-end of the housing 22 for the illustrated implementations), the compressive force of the loop 40 around the outside of the housing 22 retains the housing 22 in that position. Alternatively, the loop 40 may be welded to the housing or a portion of open loop 38 may be welded to the housing to create a rigid connection to the housing.

In FIG. 5, the attachment device 26 is in the form of a clamshell loop configuration made with a wire. The wire-form structure 34 is made from a single biocompatible wire 28. The clamshell loop 44 is adapted to mount around or over the selected ossicular portion or middle ear prosthesis. The illustrated clamshell loop 44 includes one portion which may be configured into a double-wire clamshell loop 45 as shown. The internal loop diameter of the wire clamshell loop 45 should be larger than the outer diameter of the ossicle so as to fit loosely around the ossicle. The wire is nominally 0.15 mm diameter.

The preferred wire material is a biocompatible alloy of titanium, aluminum and vanadium (e.g., TiAl.sub.6 V.sub.4) or a nickel-titanium alloy with shape memory properties.

The wire loop 46 is connected to the double-wire clamshell loop 45. The wire loop 46 is adapted to mount over the illustrated housing-magnet assembly 22. The loop 46 is disposed around the housing 22, and holds the attachment device 26 to the housing 22 of the implant 20 in the manner previously described.

Alternatively, the wire loop 46 may be welded to the housing or a portion of double-wire clamshell loop 45 may be welded to the housing to create a rigid connection to the housing.

FIG. 6 is a view of the wire-form structure 34 in a clamshell loop configuration made with a band, which maybe the same as the band 35 illustrated in FIG. 4. The wire-form structure 34 is made from a single biocompatible band 35. The clamshell loop 50 is adapted to mount around or over the selected ossicular portion or middle ear prosthesis. The internal loop diameter of the clamshell loop 50 should be larger than the outer diameter of the ossicle so as to fit loosely around the ossicle. The band is nominally 0.1 mm thick. The preferred wire material is a biocompatible alloy of titanium, aluminum and vanadium (e.g., TiAl.sub.6 V.sub.4) or a nickel-titanium alloy with shape memory properties.

The loop band 52 is connected to the clamshell loop 50. The loop 52 is adapted to mount over the illustrated housing-magnet assembly 22. As shown in the drawings, the loop 52 is disposed around the housing 22. and holds the attachment device 26 to the housing 22 of the implant 20 in the manner previously described.

Alternatively, the loop 52 may be welded to the housing or a portion of clamshell loop 50 may be welded to the housing to create a rigid connection to the housing.

FIG. 7 is a view of the wire-form structure 34 in a U-shape configuration made with a wire. The wire-form structure 34 is made from a single biocompatible wire 28. The U-shape loop 56 is adapted to mount around or over the selected ossicular portion or middle ear prosthesis. The U-shape loop 56 includes one portion which is configured into a double-wire U-shape 57. The internal loop diameter (distance between the wires) in the U-shape loop should be larger than the outer diameter of the ossicle so as to fit loosely around the ossicle. The wire is nominally 0.15 mm diameter. The preferred wire material is a biocompatible alloy of titanium, aluminum and vanadium (e.g., TiAl.sub.6 V.sub.4) or a nickel-titanium alloy with shape memory properties.

The single-wire loop 58 is connected to the double wire U-shape 57. The loop 58 is adapted to mount over the illustrated housing-magnet assembly 22. As shown in the drawings, the loop 58 is disposed around the housing 22, and holds the attachment device 26 to the housing 22 of the implant 20 in the manner previously described.

Alternatively, the loop 58 may be welded to the housing or a portion of U-shape 56 may be welded to the housing to create a rigid connection to the housing.

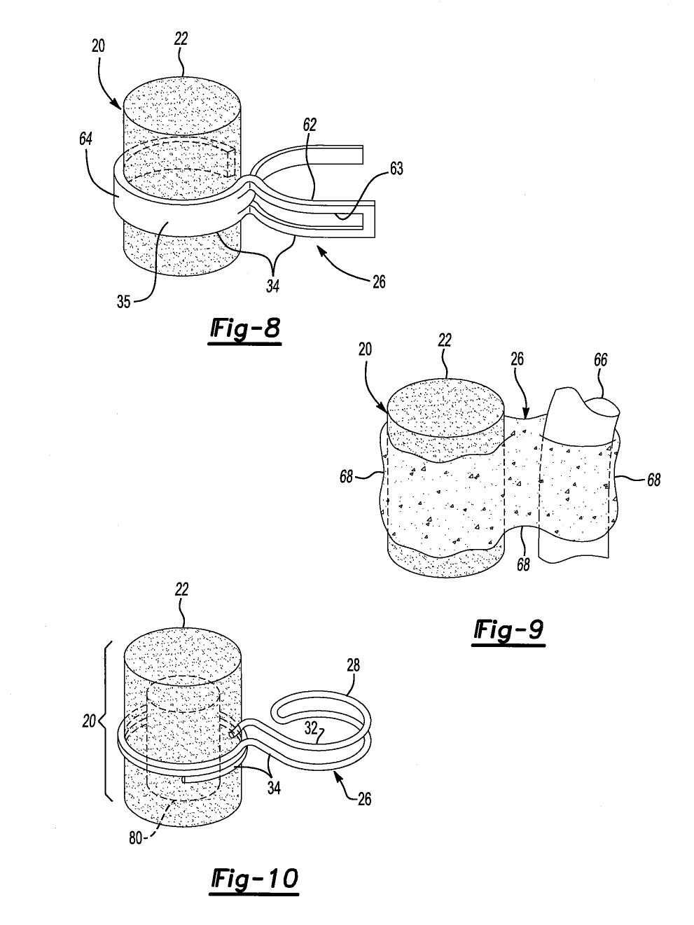

FIG. 8 is a view of the wire-form structure 34 in a U-shape configuration made with a band. The wire-form structure 34 is made from a single biocompatible band, which may be the same as the band 35 illustrated in FIG. 4. The U-shaped portion 62 of wire-form 34 is adapted to mount around or over the selected ossicular portion or middle ear prosthesis. An opening or aperture 63 may be provided in the U-shaped portion 62 of wire-form 34. The distance between the arms of the U-shaped portion 62 should be larger than the outer diameter of the ossicle so as to fit loosely around the ossicle. The band 35 is nominally 0.1 mm thick. The preferred wire material is a biocompatible alloy of titanium, aluminum and vanadium (e.g., TiAl.sub.6 V.sub.4) or a nickel-titanium alloy with shape memory properties.

The remaining loop 64 is connected to the U-shaped portion 62. The loop 64 is adapted to mount over the illustrated housing-magnet assembly 22. As shown in the drawings, the loop 64 is disposed around the housing 22 and holds the attachment device 26 to the housing 22 of the implant 20 in the manner previously described.

Alternatively, the remaining loop 64 may be welded to the housing or a portion of U-shaped portion 62 may be welded to the housing to create a rigid connection to the housing.

It will be obvious to one skilled in the art that one or more wires or bands may be used to create variations on these configurations with a rigid attachment of the wireform to the housing and a loose fit of the wireform around the ossicle.

FIG. 9 is a close up illustration of the attachment device 26 of the present invention when only biocompatible cement 68 used to attach the housing 22 of the implant 20 to a portion of the ossicular chain 66. Preferably, the cement forms completely around the ossicle and the housing like a cast thus creating a rigid connection of the housing assembly to the ossicle.

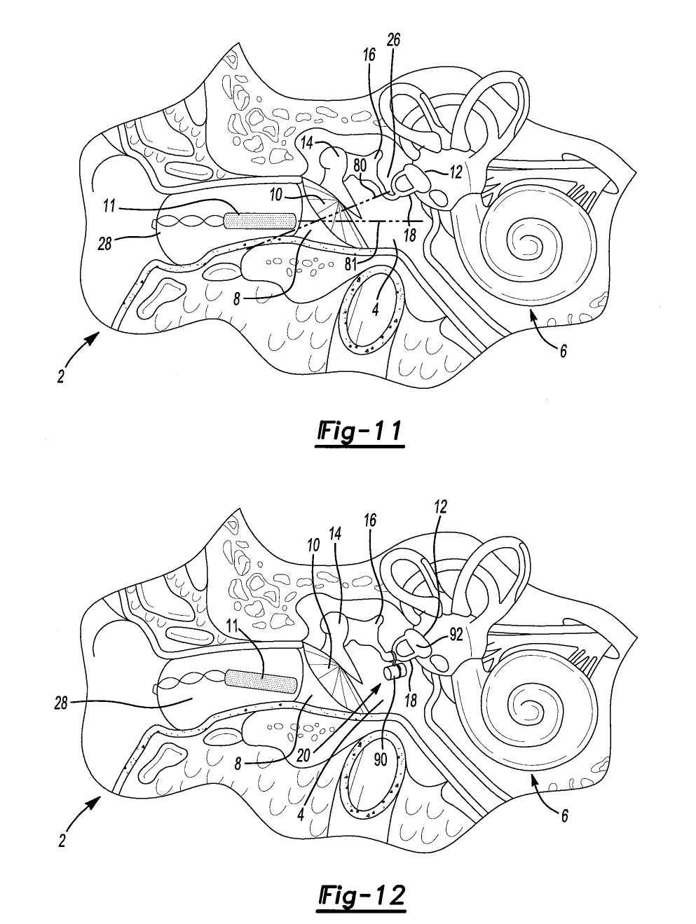

FIG. 11, in addition to showing the features of FIG. 1, also includes two dotted lines (80,81) indicating the natural path of alignment (80) of the angled ossicle, and the path needed to be in optimal alignment with the ear canal (81) (i.e. not at an angle to the transducer).

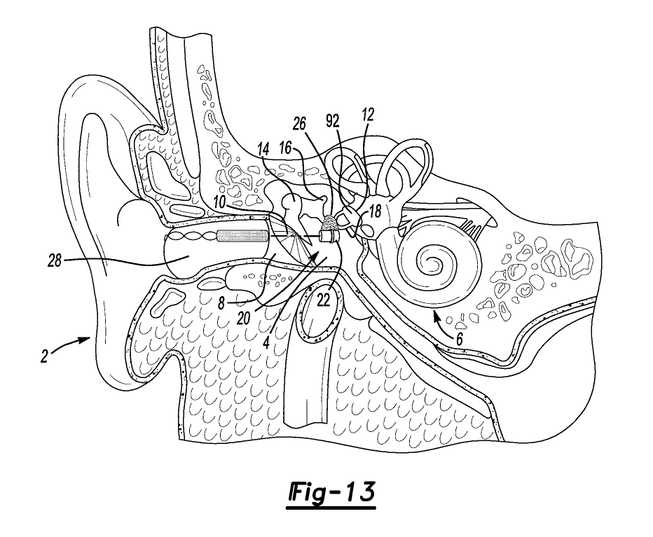

FIG. 12 illustrates the misalignment of a clamped magnet housing 90 on an angled ossicle 92, while FIG. 13 illustrates a properly aligned magnet housing 22 using attachment device 26 to hold the implant 20 on the angled ossicle 92.

Thus, the present invention is well adapted to carry out the objects and attain the ends and advantages mentioned above as well as those inherent within. While preferred embodiments of the invention have been described for the purposes of this disclosure, changes in the construction and arrangements or parts and performance of steps can be made by those skilled in the art, which changes are encompassed within the spirit of this invention as defined by the claims.

What is claimed is:

1. A method of attachment for a middle ear implant, comprising the steps of:
positioning a magnet in optimal alignment with an electromagnetic coil or extra-coil electromagnetic transducer; and attaching said magnet to at least a portion of an ossicle in the middle ear.

2. The method of claim 1, where the magnet is disposed in a housing.

3. The method of claim 2, where the housing is a hermetically sealed, commercially pure titanium canister.

4. The method of claim 3, wherein the canister has a lid, and the lid of the canister is welded to the main body of the housing in an inert gas environment, excluding oxygen from the canister.

5. The method of claim 2, where the magnet is a rare earth permanent magnet.

6. The method of claim 5, where the magnet is Nd 2 Fe.sub.14 B.

7. The method of claim 1, where the implant is attached to the at least a portion of an ossicle with biological cement.

8. The method of claim 7, where the biological cement is selected from the group consisting of hydroxylapatite and glass ionomer.

9. The method of claim 7, where the implant is first attached to the at least a portion of an ossicle using a wire-form and then anchored into optimal alignment by biological cement.

10. The method of claim 9, where the wire-form is in an open-loop configuration made with wire.

11. The method of claim 9, where the wire-form is in an open-loop configuration made with a band.

12. The method of claim 9, where the wire-form is in a clamshell loop configuration made with wire.

13. The method of claim 9, where the wire-form is in a clamshell loop configuration made with a band.

14. The method of claim 9, where the wire-form is a U-shape configuration made with wire.

15. The method of claim 9, where the wire-form is a U-shape configuration made with a band.

16. The method of claim 9, where the wire-form configuration facilitates wicking of cement into the wire-form structure.

17. The method of claim 9, where the wire-form is a biocompatible material.

18. The method of claim 17, where the biocompatible material is selected from the group consisting of gold, stainless steel, and titanium.

19. The method of claim 17, where the biocompatible material is an alloy of titanium, aluminum and vanadium.

20. The method of claim 17 where the biocompatible material is TiAl₆V₄.

21. The method of claim 17 where the biocompatible material is an alloy with shape memory properties.

22. The method of claim 21 where the alloy with shape memory properties is an alloy of nickel-titanium.

23. The method of claim 17 where the biocompatible material is a bi-metal.

24. The method of claim 10 where the wire wire-form is nominally 0.15 mm in diameter.

25. The method of claim 12 where the wire wire-form is nominally 0.15 mm in diameter.

26. The method of claim 14 where the wire wire-form is nominally 0.15 mm in diameter.

27. The method of claim 11 where the band wire-form is nominally 0.1 mm thick.

28. The method of claim 13 where the band wire-form is nominally 0.1 mm thick.

29. The method of claim 15 where the band wire-form is nominally 0.1 mm thick.

30. A middle ear implant comprising:
a magnet disposed in a housing; and
an attachment device to attach the housing to at least a portion of an ossicle in the middle ear of a patient

31. The implant of claim 30, where the housing is a hermetically sealed, commercially pure titanium canister.

32. The implant of claim 31, wherein the canister has a lid, and the lid of canister is welded to the main body of the housing in an inert gas environment, excluding oxygen from the canister.

33. The implant of claim 30, where the magnet is a rare earth permanent magnet.

34. The implant of claim 33, where the magnet is Nd.sub.2 Fe.sub.14 B.

35. The implant of claim 30, where the implant is attached to at least a portion of an ossicle of the middle ear with biological cement.

36. The implant of claim 35, where the biological cement is selected from the group consisting of hydroxylapatite and glass ionomer.

37. The implant of claim 30, where the implant is attached to the at least a portion of an ossicle using a wire-form and anchored into optimal alignment with an electromagnetic coil or extra-coil electromagnetic transducer by biological cement.

38. The implant of claim 37, where the wire-form is in an open-loop configuration made with wire.

39. The implant of claim 37, where the wire-form is in an open-loop configuration made with a band.

40. The implant of claim 37, where the wire-form is in a clamshell loop configuration made with wire.

41. The implant of claim 37, where the wire-form is in a clamshell loop configuration made with a band.

42. The implant of claim 37, where the wire-form is a U-shape configuration made with wire.

43. The implant of claim 37, where the wire-form is a U-shape configuration made with a band.

44. The implant of claim 37, where the wire-form configuration facilitates wicking of cement into the wire-form structure.

45. The implant of claim 37, where the wire-form is a biocompatible material.

46. The implant of claim 45, where the biocompatible material is selected from the group consisting of gold, stainless steel, and titanium.

47. The implant of claim 45, where the biocompatible material is an alloy of titanium, aluminum and vanadium.

48. The implant of claim 45, where the biocompatible material is TiAI₆V₄.

49. The implant of claim 45, where the biocompatible material is an alloy with shape memory properties.

50. The implant of claim 49, where the alloy with shape memory properties is an alloy of nickel-titanium.

51. The implant of claim 45, where the biocompatible material is a bi-metal.

52. The implant of claim 38 where the wire wire-form is nominally 0.15 mm in diameter.

53. The implant of claim 40 where the wire wire-form is nominally 0.15 mm in diameter.

54. The implant of claim 42 where the wire wire-form is nominally 0.15 mm in diameter.

55. The implant of claim 39 where the band wire-form is nominally 0.1 mm thick.

56. The implant of claim 41 where the band wire-form is nominally 0.1 mm thick.

57. The implant of claim 43 where the band wire-form is nominally 0.1 mm thick.
